(19) United States
(12) Patent Application Publication
(10) Pub. No.: US 2002/0162595 A1
(43) Pub. Date: Nov. 7, 2002

(54) Check valve

(75) Inventors: Jeong Ho Lee, Gyunggi-do (KR); Kwang Hyup An, Seoul (KR); In Seop Lee, Seoul (KR)

Correspondence Address: GREENBLUM & BERNSTEIN, P.L.C., 1941 ROLAND CLARKE PLACE, RESTON, VA, 20191, US

(73) Assignee: LG ELECTRONICS, Inc., Seoul (KR)

(21) Appl. No.: 10/029,973

(22) Filed: Dec. 31, 2001

(30) Foreign Application Priority Data
May 7, 2001 (KR) 24572/2001

(51) Int. Cl. F16K 15/14

(52) U.S. Cl. 137/843

(57) ABSTRACT

Disclosed is a check valve comprising a valve plate having an inlet hole that draws in a low pressure fluid by an open-and-shut operation driven by a piston movement, and a discharging hole that discharges a high pressure fluid through an open-close operation; and a check valve shaped in a helical plate spring structure coupled with the inlet hole and discharging hole of the valve plate.

Accordingly, an interference in a flow of the fluid is minimized while the valve is opened, thereby the flowing efficiency of the fluid is enhanced, and the valve is closed smoothly along to a helix, thereby noises and damage to the system caused by shock are prevented.

### BACKGROUND OF THE INVENTION

1. Field of the Invention

The present invention relates to a check valve, and more particularly, to a check valve which enhances an operating efficiency by reducing a flow resistance to increase a flow of fluid.

2Background of the Related Art

A valve, interposed in the middle of a pipeline or on a vessel to control the flow rate of fluid and pressure, varies in types and uses.

A check valve, which is employed in most of machineries that utilize liquid or gas, includes a tubular flow inhibiting plate adapted to prevent the fluid from flowing backward and guide the fluid to flow in one direction. For examples, an inlet valve and discharge valve of a reciprocating compressor are considered as the check valve.

Hereinafter will be described of the conventional check valve by taking an example of the reciprocating compressor.

FIG. 1 illustrates a structure of a compression part of the conventional reciprocating compressor.

As shown in FIG. 1, a compression member of a conventional reciprocating compressor includes: an annular cylinder 11 which has each side opened; a piston 12 being inserted at the one of the opened sides of the cylinder 11 and compressing the fluid through a reciprocating movement within the inside of an annular cylinder 11; a valve plate being installed at the opposite to the opened side in which the piston 12 is placed; an inlet valve 14; a discharge valve 15; a head cover 16 formed with a flow channel where the fluid flows in and discharges from the cylinder 11.

To describe in more detail, both sides of the cylinder 11 are opened, such that the piston 12 is inserted to the one side, and the other side of the cylinder 11 is adapted of the valve plate 13, inlet valve 14, discharge valve 15 and the head cover 16, thereby controlling a flow of the fluid.

The piston 12 is the component that performs a linear reciprocating movement in the inside the cylinder by a rotation of a motor (not shown in the drawings) mounted in the inside of the reciprocating compressor, which shows an inflow and compression stroke cycle repeatedly.

In the meantime, the valve plate 13, the inlet valve 14, the discharge valve 15 and the head cover 16 will be made in detail from the following description taken in conjunction with the accompanying drawings.

FIG. 2 is an exploded view illustrating a valve plate, inlet valve, discharge valve and head cover of the conventional reciprocating compressor.

The valve plate 13 is a part that supports the inlet valve 14 and discharging valve 15 that control the flow of the fluid flows in and out of the cylinder. The valve plate 13 includes an inlet hole 13a for drawing in the fluid and a discharging hole 13b for discharging the fluid.

The inlet valve 14 is the member interposed between the valve plate 13 and cylinder 11, on which is positioned an inlet plate 14a on the corresponding location to that of the inlet hole 13a of the valve plate 13.

Also, the discharge valve 15 is the element positioned between the valve plate 13 and head cover 16, and attached with a discharging plate 15a at the place opposing the discharging hole 13b of the valve plate 13.

The head cover 16 is the member defining the flow channel of the fluid that draw in and discharges from the cylinder. The head cover includes: an inlet pipe 16a formed on the position which corresponds to that of the inlet hole 13a of the valve plate; a discharge pipe 16b formed on the position which corresponds to that of the discharge hole 13b of the valve plate.

To examine the operation of reciprocating compressor that includes the inlet valve 14 and discharging valve 15, which are the conventional check valve according to the above described construction, when the piston 12 moves backward in the inside the cylinder 11 by the rotation of the motor(not shown in the drawings) of the piston 12, the fluid flips open the inlet plate 14a of the inlet valve as the pressure drops down and flows in from the inlet pipe 16a of the head cover. The fluid, that has been drawn in through the above process, is then compressed as the piston 12 moves forward as a result of rotation of the motor, which then flips the discharge plate 15a of the discharge valve supported by the spring and the like, thereby discharging to the outside via the discharge pipe 16b of the head cover.

FIG. 3 is an exploded view illustrating the operation of the inlet valve of the conventional reciprocating compressor.

First, to examine the process of which the fluid flows into the cylinder, the fluid that flew into the inlet hole 13a of the valve plate as a result of the backward movement of the piston bends flips the inlet plate 14a of the inlet valve and then flows into the cylinder.

The fluid, that has been drawn in through the above process, is then compressed by forward movement of the piston 12, and the inlet plate 14a is then closed by the compressed fluid.

The aforementioned processes are continuously occurred as the piston 12 moves back-and-forth, and the opposite operation to that of the inlet valve occurs at the discharging valve.

However, due to the inlet plate 14a not being completely bent backward, as mentioned above, an obstacle that interfering the flow path of the fluid that flows into the inlet plate 14a has been created. Moreover, the inlet plate 14a that closes during the discharging process collides with the valve plate 13 creating loud noise.

The above-mentioned problems cause decrease in over all efficiency of the compressor and the loud noise may cause unpleasant environment to a user.

### SUMMARY OF THE INVENTION

Accordingly, the present invention is directed to a check valve that substantially obviates one or more problems due to limitations and disadvantages of the related art.

An object of the present invention is to provide the check valve which could reduce the noise and increase a fluid efficiency, thereby improving a performance of the whole system.

The check valve according to the present invention is formed in a helical plate spring shape to prevent a flow of the fluid when the fluid flows in one direction by maintaining a pressured state as the parts of the check valve overlaps, and in case the fluid flows in the other direction, the valve is stretched out to promote the fluid to flow in.

The objectives and other advantages of the invention may be realized and attained by the structure particularly pointed out in the written description and claims hereof as well as the appended drawings.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view showing a structure of a compression part of the conventional reciprocating compressor;

FIG. 2 is a schematic view illustrating a valve plate, inlet valve, discharge valve and head cover of the conventional reciprocating compressor;

FIG. 3 is a diagram illustrating an operation of an inlet valve of the conventional reciprocating compressor;

FIG. 4 a plan view showing the structure of a check valve according to the preferred embodiment of the present invention;

FIG. 5 is an exploded view illustrating an operation of a check valve according to the preferred embodiment of the present invention; and

FIG. 6 a perspective view a structure of a check valve according to another preferred embodiment of the present invention.

### DETAILED DESCRIPTION OF THE PREFERRED EMBODIMENTS

A check valve, according to the present invention, is formed in a helical plate spring shape, such that it could reduce the noise and increase a fluid efficiency by minimizing the fluid flow interference caused by the check valve during the opening.

Reference will now be made in detail to the preferred embodiments of the present invention, examples of which are illustrated in the accompanying drawings. Similar reference numerals identify corresponding parts.

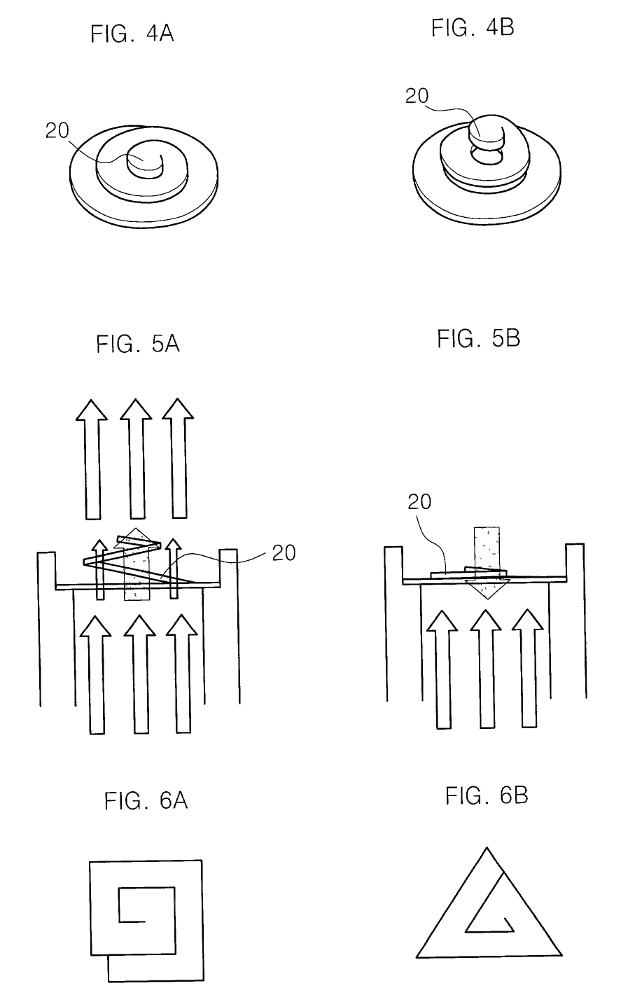

FIG. 4 illustrates a structure of a check valve according to the preferred embodiment of the present invention.

As referring to FIG. 4, the check valve according to the present invention is formed in a helical plate spring 20, such that it prevents the fluid flow, in case the fluid flows in one direction, as the pressure is compressed in a manner of piling partly of the part of an apparatus, whereas when the fluid flows in the other one direction, the valve is stretched so as to promote the fluid flow.

An operation of the check valve constructed as above is illustrated in FIG. 5.

FIG. 5 is an exploded view illustrating an operation of a check valve according to the preferred embodiment of the present invention.

Referring to FIG. 5, a helical plate spring 20, the check valve according to the present invention, is stretched, in case a fluid is flown in the direction where the helical plate spring 20 is to pass trough, as its length is extended due to a pressure of the flown fluid, and such stretch makes a gap to which the fluid could flow through. The above gap will occurred in total part of the helical plate spring 20, such that a circulation of the fluid is performed smoothly, and this smooth circulation of the fluid will enhance the performance of the whole system.

Meanwhile, as shown in FIG. 5(b), in case the fluid flows in the direction opposite from which the fluid should pass through, the helical plate spring 20 is compressed to be a compressed state by a pressure of the fluid, for the helical plate spring 20 is formed in a helical plate spring structure of which the part of apparatus is piled partly, thereby flowing through of the fluid is prevented. During the above process, the helical plate spring 20 is compressed smoothly along a helix, which will reduce a shock put on a member, thereby reducing noises and simultaneously increasing a lifespan of the component.

Hereafter will describe a preferred embodiment of a reciprocating compressor applied with the check valve according to the present invention.

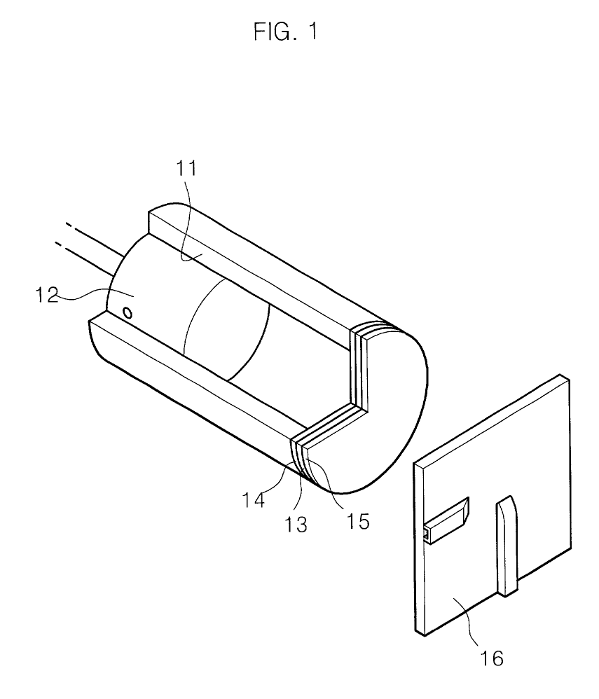

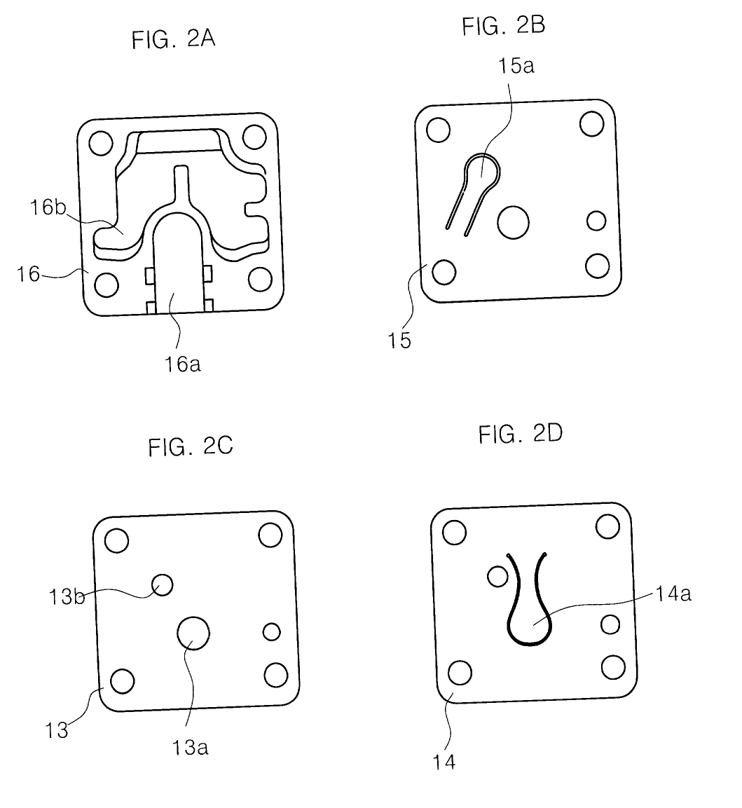

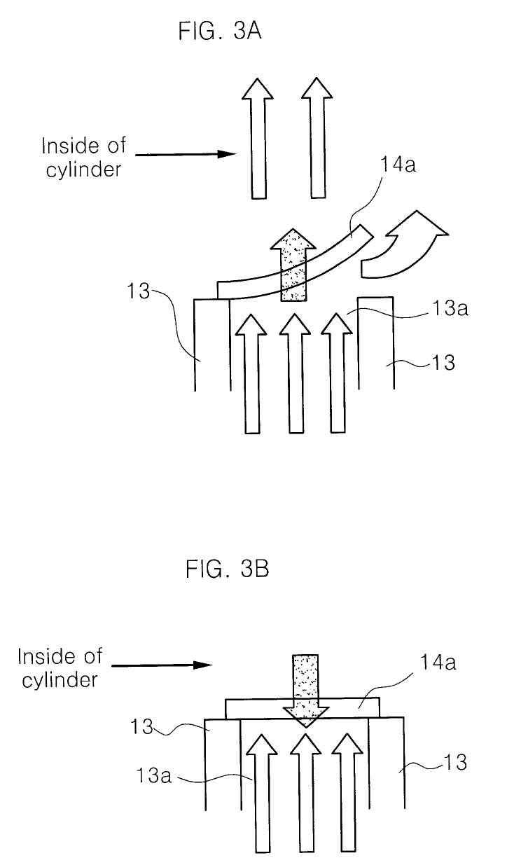

The reciprocating compressor comprising the conventional check valve includes, as mentioned in FIG. 1, a plate-shaped inlet valve and discharge valve respectively adapting an inlet plate and discharging plate on a predetermined portion thereof, in which is inserted a valve plate therebetween.

A check valve according to the present invention will be explained in reference with FIG. 1 and FIG. 5. A helical spring check valve 20 is stretched as shown in FIG. 5(a), as the force is applied to the helical spring check valve 20 in the direction from the outside to inside of the cylinder 11 at a moment when an inside pressure, which is decreasing, of the cylinder 11 becomes lower than an inside pressure of a inlet muffler (not shown in the drawings).

Here, the fluid (such as a refrigerant) contained in inside the inlet muffler flows directly through the gap that has been opened up as the helical spring check valve 20 is stretched out into the cylinder, thereby a fluid resistance is reduced and greater amount of the fluid can be drawn in during the inlet process enhancing the compression efficiency of the compressor.

When the inlet process is continued and the fluid is filled in the cylinder 11, the inner pressure of the cylinder 11 is increased, thereby the helical spring check valve 20 will be applied with the force in the direction of the inlet muffler causing the helical spring check valve 20 to close as illustrated in FIG. 5(b).

When the piston 12 moves to the upper dead center via the bottom dead center, the refrigerant in the cylinder is compressed, which increases the inner pressure allowing the helical spring check valve 20 to remain in the closed state.

Although, some machine noise may be generated as the piled up portions of each floor of the helical spring check valve 20 collide when the check valve is closed, the high frequency noise created when the check valve 20 collides directly with a valve plate 13 is not generated, therefore, the noise of the compressor is decreased.

The reciprocating compressor comprising the check valve according to the present invention could still utilizes the valve plate 13 by disposing supporting plates on both faces of the valve plate, and inserting the check valve according to the present invention between the supporting plates and the valve plates 13. Moreover, the check valve in accordance with the present invention could be used by replacing the conventional inlet plate 14a and discharge plate 15a of inlet valve 14 or discharge valve 15 respectively on the same location where the inlet plate 14a and discharge plate 15a have been positioned. Furthermore, the check valve 20 can be used to replace the conventional inlet plate 14a and discharge plate 15a. Here, the diameter of the check valve 20 should be adjusted in order to be inserted and fixed on the inlet hole 13a or the discharging hole 13b of the valve plate 13.

Still, the check valve 20 according to the present invention could be used for either the inlet hole 13a or discharge hole 13b, or both.

In addition, helical plate spring shape, which is the structure of the check valve according to another preferred embodiment of the present invention as shown in FIG. 6, could be made in other shapes such as a circular helix shape, a triangular helix shape and a rectangular helix shape depending on the valve plate and head cover.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

As explained above, a check valve according to the present invention is formed in helical plate spring shape which the part of an apparatus is piling up, enabling to minimize an interference in a fluid flow while the valve is opened, thereby enhancing the circulation efficiency of the fluid and thus closing the valve smoothly along to a helix, thereby preventing noises and damage of a machine caused by a shock.

What is claimed is:

1. A check valve comprising:
a valve plate having an inlet hole that draws in a low pressure fluid by an open-and-shut operation driven by a piston movement, and a discharging hole that discharges a high pressure fluid through an open-close operation; and
a check valve shaped in a helical plate spring structure coupled with the inlet hole and discharging hole of the valve plate.

2. The check valve of claim 1, wherein a flow of the fluid is blocked or allowed to flow smoothly by pressure differences in the check valve.

3. The check valve of claim 1, wherein the check valve is coupled with supporting plates which have an inlet member or a discharging member.

4. The check valve of claim 1, wherein the check valve is structured in a stair shape of which the width becomes narrower as going up to upper part from below part.

5. The check valve of claim 4, wherein each floor of the check valve is opened by a pressure of an outside fluid that has been generated by the piston movement.

6. The check valve of claim 1, wherein the fluid is a refrigerant.

7. The check valve of claim 1, further comprising a head cover, which is formed with a flow channel where the fluid draws in and discharge from, for sealing the valve plate in order to prevent a leakage of the fluid.

8. A check valve shaped in helical plate spring shape to prevent a flow of the fluid when the fluid flows in one direction by maintaining a pressured state as the parts of the check valve overlaps, and in case the fluid flows in the other direction, the valve is stretched out to promote the fluid to flow in.

9. The check valve of claim 8, wherein helix shape of the helical plate spring check valve is at least one of circular helix shape, triangular helix shape and rectangular helix shape.

10. A check valve comprising:
a valve plate having an inlet hole which draws in a low pressure fluid by an open-and-shut operation driven by a piston movement and a discharging hole through that discharges a high pressure fluid by an open-and-shut operation;
a check valve shaped in a helical plate spring structure coupled with the inlet hole and discharging hole of the valve plate; and
a head cover, which is formed with a flow channel where the fluid draws in and discharge from, for sealing the valve plate in order to prevent a leakage of the fluid.
